(19) United States
(12) Patent Application Publication
(10) Pub. No.: US 2025/0386982 A1
(43) Pub. Date: Dec. 25, 2025

(54) UTILITY HOLDER

(71) Applicants: John M. Tursky, Hillsborough, NJ (US); Andrii Velhov, Somerset, NJ (US); Matthew Ruzicka, Jackson, NJ (US); Harikrushna Patel, Secaucus, NJ (US)

(72) Inventors: John M. Tursky, Hillsborough, NJ (US); Andrii Velhov, Somerset, NJ (US); Matthew Ruzicka, Jackson, NJ (US); Harikrushna Patel, Secaucus, NJ (US)

(21) Appl. No.: 18/825,150

(22) Filed: Sep. 5, 2024

Related U.S. Application Data
(63) Continuation-in-part of application No. 18/747,848, filed on Jun. 19, 2024, now Pat. No. 12,458,162.

(51) Int. Cl. A47K 5/12; B67D 1/08; G01F 23/00

(52) U.S. Cl. CPC A47K 5/1217; B67D 1/0871; G01F 23/0015

(57) ABSTRACT

A utility holder (100) for a soap dispenser, comprises an enclosure (102) adapted to mount on a wall. A holding bracket (106) is attached at the bottom end (110) of the enclosure (102) to accommodate a soap dispenser. A fixture clamp (104) is fastened at the top end (110) of the enclosure (102) for clamping the soap dispenser. A locking mechanism, installed in the enclosure (102) locks the height of the holder (100) as per the dimensions of the soap dispenser. A sensing module integrated at the bottom end (110) of the holder (100) comprises an ultrasonic gel pad (112) to provide an acoustic isolation at the bottom of the soap dispenser to detect the real-time level of the liquid soap present within the soap dispenser.

### CROSS-REFERENCE TO RELATED APPLICATIONS

This application is a continuation in part of U.S. patent application Ser. No. 18/747,848, entitled “UTILITY HOLDER,” filed on Jun. 19, 2024, which is hereby incorporated by reference in its entirety.

### BACKGROUND OF THE INVENTION

### 1. Field of the Invention

The present invention pertains to the field of utility items, and more particularly to a utility holder designed to hold and secure different equipment or items, for example, soap dispensers, shampoo dispensers, and the like, of different designs and dimensions.

### 2. Description of the Prior Art

Utility-type holders are versatile and practical solutions designed to securely store and organize a variety of items, including household or commercial items. These holders come in various forms, such as wall-mounted racks, adhesive hooks, and freestanding stands, tailored to different environments and needs. Made from durable materials like stainless steel, plastic, or rubber, they ensure stability and longevity. Their design often includes features like adjustable arms or non-slip surfaces to accommodate items of different sizes and weights. By keeping items neatly arranged and easily accessible, utility-type holders enhance the functionality of spaces and contribute to a more organized and efficient living or working environment.

For example, a liquid dispenser holder is often used in various domestic as well as public facilities, such as homes, schools, offices, hotels, restaurants, and many more, to accommodate a liquid soap dispenser, shampoo and conditioner dispensers, body wash dispensers and the like. The purpose of utilizing such dispenser holders is to secure the above-said dispensers, in a specific place to avoid spillage, to provide convenience to individuals while using such liquid dispensers, and to maintain hygiene standards. The known liquid dispenser holders are available in different shapes and sizes in the market. Such holders possess a fixed structure and, therefore, can accommodate only a specific size of liquid dispensers.

The known liquid dispenser holders do not provide any room for adjustment of the size corresponding to the dispenser's dimensions. Hence, to accommodate varying-sized liquid dispensers, one must replace the dispenser holders corresponding to the size of the liquid dispensers, which eventually increases costs. Further, the existing designs of dispenser holders limit adequate safeguard of the liquid soap dispenser and shampoo dispensers against unauthorized removal by individuals. This becomes particularly crucial in public or shared facilities where preventing unauthorized usage by strangers is essential for upholding hygiene standards and managing expenses effectively.

U.S. Pat. No. 11,918,158B2 discloses a product dispenser holder having a holder body designed to accommodate a product dispenser containing the product to be dispensed. It includes an actuation sensor to detect activations of the product dispenser, along with an actuation button. When pressure is applied to the dispenser's pump, it exerts a downward force on the actuation button, causing it to rotate downward and trigger the actuation sensor, generating a signal indicating dispenser activation.

Such known utility holders are mainly focused on providing a holder that mostly ensures user convenience during liquid dispensing, such as liquid soap, shampoo, and many more. However, such dispensers fail to address the crucial aspect of safeguarding the attached dispenser against unauthorized access. Additionally, they do not provide size adjustment features for various-sized liquid dispensers.

Furthermore, another problem that past approaches failed to address is that, conventionally, many hotels used single-use plastic bottles for amenities like shampoo, conditioner, and body wash. These non-refillable bottles were disposed of after use, leading to significant waste and high costs. Hence, to tackle such issues, the hotels began to utilize refillable metallic bottles made of steel, aluminum, and the like. While the aluminum bottles were a step forward in reducing waste, their opaque nature raises new challenges for housekeeping staff.

The housekeeping staff found it difficult to accurately gauge the remaining liquid levels, making manual inspections cumbersome and prone to error. This inefficiency complicated inventory management and impacted guest satisfaction. Although the move from single-use plastics to reusable metallic bottles has led to sustainability, the challenges of manual monitoring highlight the need for innovative solutions to improve efficiency and ensure effective inventory management.

Moreover, a notable drawback of reusable liquid dispensers, due to their opaque nature, is no one can know when the amount of liquid needs to be replenished or how much needs to be added, which, when manually checked, leads to inefficient management of inventory. Therefore, precise tracking of liquid levels is crucial for maintaining optimal stock levels. Without accurate refilling indicators, it becomes challenging to manage inventory effectively, potentially resulting in overstocking or stockouts. Thus, there also exists a need to develop a mechanism that accurately measures the amount of liquid contained in liquid dispensers and indicates the same to an inventory management system.

### Objectives of the Invention

An objective of the present invention is to develop a holder for liquid dispensers that secures the liquid dispenser in an upright position to avoid or eliminate the spillage of liquid soap, thereby reducing wastage.

Another objective of the present invention is to prevent the unauthorized removal of liquid dispensers in public or hotel facilities, thereby preventing the risks of theft.

Another objective of the present invention is to provide a holder that is adaptable to accommodate various-sized soap dispensers, thereby eliminating the need for a product-specific holder corresponding to the size of the liquid dispenser.

Another objective of the present invention is to provide a liquid dispenser holder that allows remote monitoring of the real-time level of liquid-filled-in liquid dispensers.

Another objective of the present invention is to provide a hand-held device for measuring the level of liquid in an opaque container, which, in combination with an inventory control system, enhances the management of liquids in various applications.

Another objective of the present invention is to provide a holder that utilizes reusable liquid bottles, thus preventing wastage and reducing the costs of investments.

Yet another objective of the present invention is to develop a holder that has an ergonomic design, ensuring space optimization

### SUMMARY OF THE INVENTION

The present invention provides an adjustable soap dispenser holder, for a reusable soap dispenser bottle of different sizes. Said utility holder includes a locking mechanism to prevent unauthorized removal of the soap dispensers and a sensing mechanism for detecting the level of soap present in the reusable bottle. The disclosed invention provides a provision of utilizing reusable liquid bottles preventing wastage of liquid and reducing cost.

According to an embodiment of the present invention, a utility holder for a liquid dispenser includes an enclosure adapted to mount on a wall. A holding bracket is attached at a bottom end of the enclosure to accommodate a liquid soap dispenser. A fixture clamp is fastened at the top end of the enclosure for clamping the soap dispenser, and a locking mechanism is incorporated within the enclosure. The utility holder includes a sensing module embedded at the bottom end of the holder and comprises an ultrasonic gel pad to provide acoustic isolation at the bottom of the soap dispenser for real-time detection of the liquid soap level in the soap dispenser.

In an embodiment, the enclosure has a hollow rectangular-shaped structure.

In another embodiment, the fixture clamp has a semi-circular shape.

According to another embodiment, the present invention provides a liquid dispenser system comprising a dispensing unit having a holder and a container to hold a liquid to be dispensed herein, at least one ultrasonic sensor coupled to the body of the holder to measure the amount of liquid within the container and an electronic unit coupled to the dispensing unit. The electronic unit includes a sensing module comprising a processing module and a communication module. The processing module enables the electronic unit to receive signals from at least one ultrasonic sensor, process them to provide values for display on a display device and communicate the values to a remote server over a network for inventory management.

### BRIEF DESCRIPTION OF THE DRAWINGS

The invention will be more fully understood, and further advantages will become apparent when reference is had to the following detailed description of the preferred embodiments of the invention and the accompanying drawings, in which:

FIG. 1A is a side view of a utility holder for soap dispensers, in accordance with an embodiment of the present invention;

FIG. 1B is a perspective view depicting the utility holder of FIG. 1A;

FIG. 2A is a schematic depicting a front view of a liquid-level measuring device 200;

FIG. 2B illustrates schematically the internal electronic configuration of the device 200 in FIG. 2A;

FIG. 2C depicts the utilization of the handheld liquid-level sensing device 200 shown by FIG. 2A within a hotel setting accompanied by the utility holder of FIGS. 1A and 1B;

FIG. 2D depicts the utilization of the handheld liquid-level sensing device 200 in use within a bar setting;

FIG. 2E is a side view of the handheld liquid dispenser of FIG. 2A; and

FIG. 3 illustrates a schematic view of a liquid dispenser system.

### DETAIL DESCRIPTION OF THE INVENTION

The embodiments herein and the various features and advantageous details thereof are explained more fully with reference to the non-limiting embodiments that are illustrated in the accompanying drawings and the following description. Numerous variations, changes, and substitutions may occur to those skilled in the art without departing from the invention. It should be understood that various alternatives to the embodiments of the present disclosure herein may be employed.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms used in the application, as all equivalents, synonyms, new developments, and terms or techniques that serve the same or a similar purpose are considered to be within the scope of the present claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

The present invention relates to a utility holder capable of facilitating the accommodation of liquid soap dispensers of various sizes while optimizing the space requirements, preventing unauthorized removal of the soap dispensers, and providing a provision of real-time monitoring of liquid level filed in liquid dispensers such as soap dispensers, shampoo, conditioner dispensers, and the like.

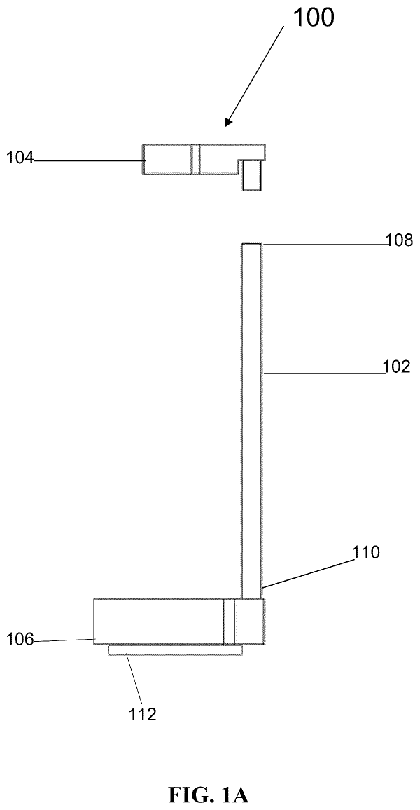

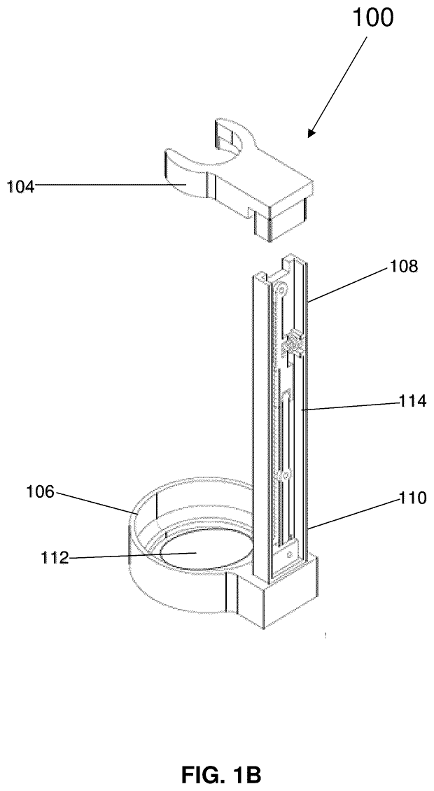

FIGS. 1A-1B illustrate different views of a utility holder for the soap dispenser. Herein, the holder 100, comprises an enclosure 102 affixed with a fixture clamp 104 and a holding bracket 106. Enclosure 102 is a hollow tube that possesses a cuboidal-shaped structure and is adapted to be mounted on a wall. The Enclosure 102 includes a top-end 108 and a bottom-end 110. At the top end 108, the fixture clamp 104 is affixed, while at the bottom end 110, the holding bracket 106 is attached via an inner tube 114 (as illustrated in FIG. 1B) of the holder 100. The Enclosure 102 envelops the inner tube 114 and various internal components associated with the holder 100.

Further, enclosure 102 joins the fixture clamp 104 and holding bracket 106 so that the fixture clamp 104 and holder 100 collaboratively grip the soap dispenser therebetween. In an embodiment, the fixture clamp 104 comprises a semi-circular shape that aids in convenience by providing a firm grip on the soap dispenser.

Further, FIG. 1B illustrates various internal components associated with the holder 100. Here, FIG. 1B presents a locking mechanism installed in the inner tube 114. The locking mechanism comprises a magnetic block coupled with an end of a centrally pivoted lever, pivoted with the inner tube 114. A secondary lever has an end engaged with the centrally pivoted lever. A linear ratchet is installed within enclosure 102 and comprises a plurality of teeth that are adapted to be engaged with the secondary lever through a pawl formed at an edge of the secondary lever. A spring is provided in connection with the secondary lever and inner tube 114. This configuration of the inner tube 114 with all relevant components of the locking mechanism forms a sub-assembly within the enclosure 102.

The inner tube 114 is the internal key component of the holder 100 and is adapted to be inserted inside enclosure 102. The inner tube 114 has different shaped structures, including rectangular, cuboidal, etc., which provide a base for all the internal components of the holder 100. In an embodiment, the inner tube 114 comprises a hollow and/or rigid structure.

Further, the inner tube 114 is provided with the holding bracket 106, attached at an end of the inner tube 114, such that the holding bracket 106, on insertion of inner tube 114 inside the enclosure 102, comes in proximity to the bottom end 110 of enclosure 102 (as shown in FIG. 1B). The holding bracket 106 is adapted to accommodate the liquid soap dispenser. In an embodiment, the shape of the holding bracket 106 is a circular plate-like structure. In another embodiment, the shape of the holding bracket 106 is a ring-like structure (as illustrated in FIG. 1B).

The holding bracket 106 disclosed above comprises a sensing module which is integrated at the bottom end 110 of the holder 100. The sensing module comprises an ultrasonic gel pad 112, which provides an acoustic isolation at the bottom of the soap dispenser holder 100 for real-time detection of the level of liquid soap in the dispenser.

According to another embodiment, the above-mentioned utility holder 100 can be implemented/utilized in a liquid dispenser system.

FIG. 3 illustrates a schematic view of a liquid dispenser system comprising a dispensing unit having a holder 100 and a container (which may be a soap dispenser). Container 202 holds or stores a liquid to be dispensed.

In an embodiment, the liquid to be stored may be any fluid, such as but not limited to liquid soap, liquor items, and the like.

Further, holder 100 is integrated with at least one ultrasonic sensor coupled to a body of holder 106. At least one ultrasonic sensor integrated with ultrasonic gel pad 112 strategically affixed to the bottom end 110 of the holding bracket 106 for measuring the amount of liquid filled in container 202. The ultrasonic gel pad 112 provides acoustic isolation at the bottom of container 202 for real-time detection of the level of liquid present within container 202.

The ultrasonic gel pad 112 is made from a specialized acoustic gel with optimal transmission properties. The ultrasonic gel pad 112 ensures efficient coupling with the container's 202 bottom side. This configuration allows ultrasonic waves emitted by the gel pad 112 to be effectively transmitted through the liquid, facilitating the accurate distance measurement between the gel pad 112 and the liquid surface. The ultrasonic gel pad 112 integrates embedded ultrasonic transducers that generate and receive high-frequency sound waves. The time-of-flight of these waves is analysed to determine the liquid level, providing real-time, reliable data on the volume of liquid present inside container 202.

The advanced acoustical technology of ultrasonic gel pad 112 minimizes signal distortion and maximizes wave propagation efficiency, ensuring consistent performance across various environmental conditions and container types. This design enables seamless liquid-level monitoring without the need for external sensors or intrusive modifications, offering an accurate solution for diverse applications.

The detected data from the ultrasonic gel pad 112 is further transmitted to an electronic unit integrated with the dispensing unit. The electronic unit comprises a sensing module, a processing module, and a communication module 200 that works collaboratively to process, evaluate, and communicate the received data signals. The sensing module, after receiving the data signals from the ultrasonic gel pad 112, analyses the ultrasonic signals to determine the precise liquid level present inside container 202.

The sensing module filters and amplifies the received ultrasonic signals to improve accuracy and reduce noise by employing processing algorithms to compute the distance to the liquid surface based on the time-of-flight data. This processed information is subsequently transmitted to a processing unit provided in the electronic unit. The processing unit disclosed here is implemented as a microcontroller. In an embodiment, the microcontroller used here is an Arduino Nano 33 BLE Sense microcontroller.

On receiving the output from the gel pad 112, the processing module analyses the ultrasonic signals by employing advanced signal processing algorithms and converts the analog signals from the sensing module to a digital output using its integrated analog-to-digital converter (ADC). These algorithms decode the time-of-flight data and convert it into a digital signal that accurately represents the real-time liquid level present within container 202. In the use of ultrasonic sensors, there is oftentimes encountered a “blind” zone, which makes readings of lower liquid levels inaccurate or impossible. A sensor solution that involves dual transducers and implements a dual transducer measurement technique virtually eliminates the blind zone and provides accurate readings with minimal resolution, which can be critical for Hospitality and other industries that require accurate readings of the liquid level for inventory management.

The digital output is then processed to provide precise measurements, which can be displayed on a user interface or transmitted to a remote monitoring system. This conversion from analog to digital ensures high resolution of the liquid level, which is further formatted for integration with digital systems for display, monitoring, or further data processing.

As shown in FIG. 3, the processed data signals are further transmitted to a server 206 through the communication module 204. In an embodiment, the communication module 204, may use wireless technologies such as Wi-Fi, Bluetooth, or cellular networks, and facilitates seamless data transfer over a network. It encodes the digital signals into packets suitable for wireless transmission, ensuring reliable and efficient communication between the processing module and the server 206. The server 206 then receives, stores, and processes the data for further analysis.

The final output and evaluated values are displayed by a connected display device, providing immediate visual feedback on the liquid level. In an embodiment, the display device mentioned above can be any display screen connected wirelessly to server 206.

In an alternative embodiment, the evaluated data can be accessed by concerned users by wirelessly connecting their user devices such as mobile phones, and tablets, to the server, allowing for remote monitoring and management of the liquid level information from any location. This comprehensive system 200 ensures real-time visibility and control, enhancing user accessibility and providing values for the real-time level of liquid filled in the container for inventory management purposes.

The present invention can be implemented to accommodate various types of liquid bottles, where ongoing monitoring and record-keeping of the liquid content are essential. For example, sanitizer bottles used in hospitals, liquor bottles in retail shops, or inventory bottles in oil industries.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within understood that the phraseology or the terminology employed herein is for description and not of limitation. Therefore, while the embodiments herein have been described in terms of preferred embodiments, those skilled in the art will recognize that the embodiments herein can be practiced with modification within the spirit and scope of the appended claims.

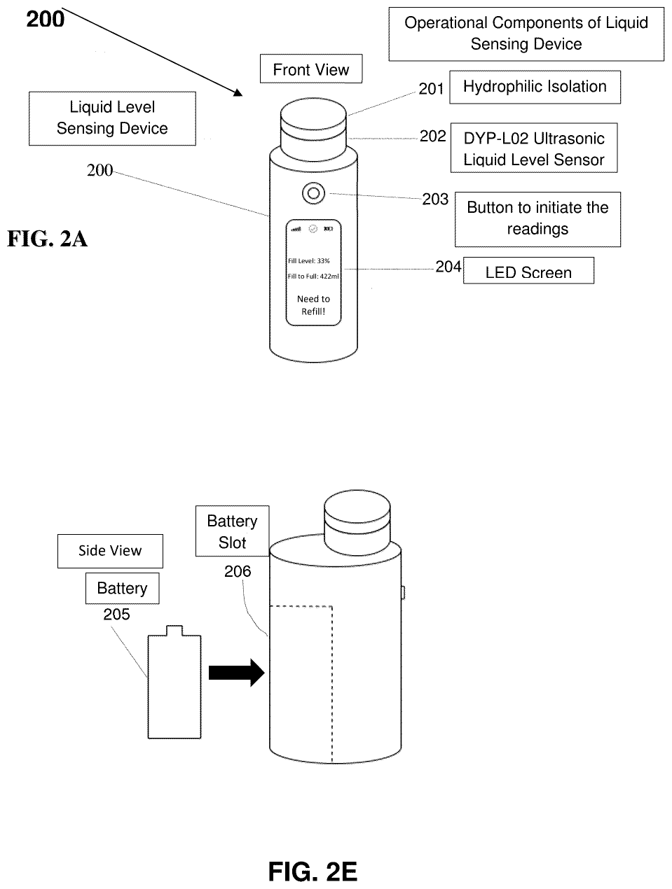

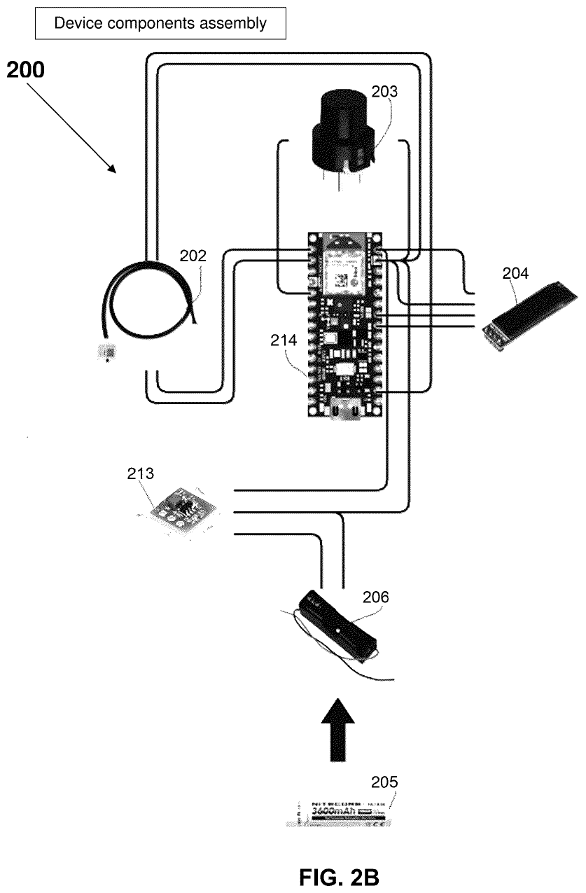

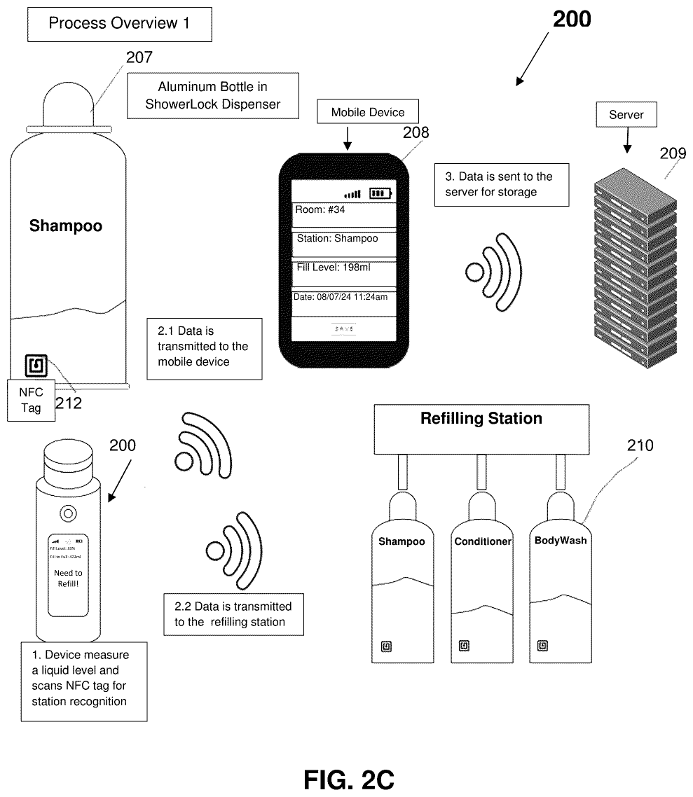

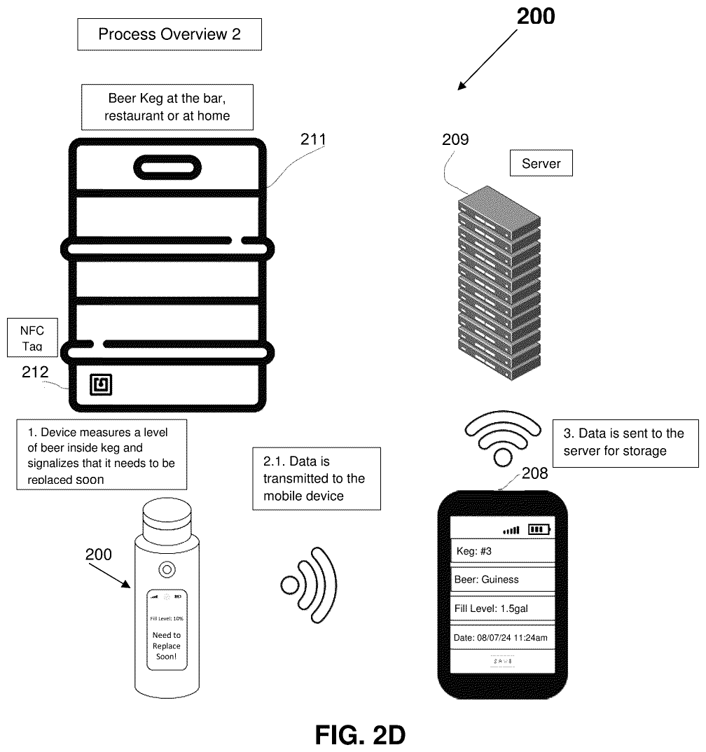

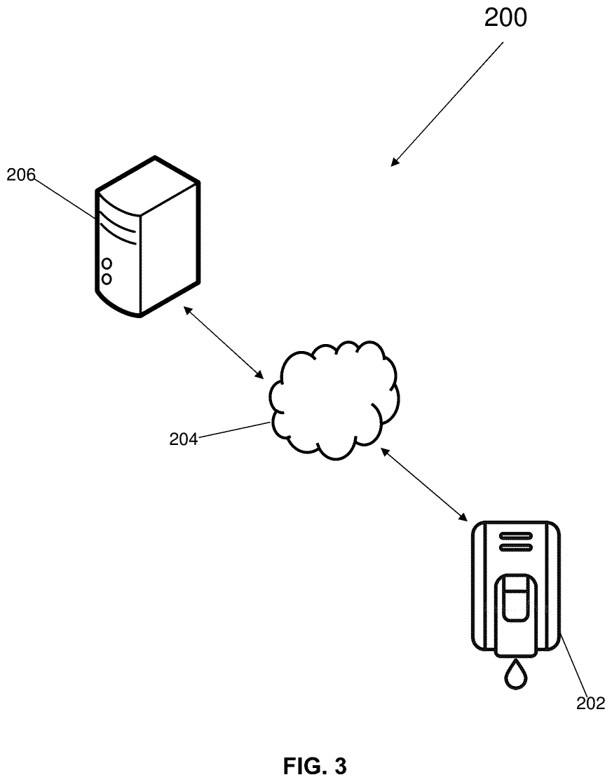

Referring to FIGS. 2A-2D, there is shown a handheld liquid level sensing device, designated as item 200. This device is designed to measure the fill levels within containers, such as aluminum bottles (item 207) and beer kegs (item 211), without requiring their removal from their respective holders. The device 200 includes a DYP-L02 Ultrasonic Liquid Level Sensor, labeled as item 202, strategically positioned to determine the liquid level by emitting ultrasonic waves. These waves reflect off the liquid surface inside the container, and sensor 202 calculates the level based on the time of flight of the reflected waves. To ensure accurate measurements, device 200 features a hydrophilic isolation pad, identified as item 201, which serves as a coupling medium to improve ultrasonic wave transmission.

The handheld device 200 further comprises a user interface with an LED screen 204 that displays the measured liquid level and other relevant information. A button 203 is provided to initiate the measurement process. The ergonomic design of device 200 allows it to be easily handled by maintenance personnel in environments such as hotels and restaurants. Additionally, device 200 includes a communication module that enables data transmission to external devices for further processing or inventory management.

FIG. 2B illustrates the internal electronic configuration of the handheld device 200. At the core of this configuration is the Arduino Nano 33 BLE Sense microcontroller, referenced as item 214, which serves as the central processing unit. Microcontroller 214 receives data from the ultrasonic liquid level sensor 202, processes this data, and then displays the calculated liquid level on the LED screen 204. As shown in FIG. 2E, device 200 is powered by a rechargeable battery 205, housed in a battery slot 206, ensuring uninterrupted operation. Additionally, a voltage booster 213, is integrated to maintain a stable power supply to all components.

FIG. 2C provides an overview of the handheld liquid level sensing device 200 in use within a hotel setting. In this application, device 200 is used to measure the liquid level in refillable aluminum bottles 207, containing soap, shampoo, or conditioner, which are secured in a shower lock dispenser. Device 200 allows for non-intrusive measurement of liquid levels, ensuring that the bottles remain locked in place during the process.

When device 200 is placed against the bottom of a secured bottle 207, the ultrasonic sensor 202 emits waves that reflect off the liquid surface. The resulting data is processed by microcontroller 214, which then calculates the fill level and displays it on the LED screen 204. The device 200 also reads an NFC tag 212, attached to the bottle's station, identifying the specific bottle and transmitting the data to a mobile device 208 via Bluetooth. This data is then relayed to a server 209, for inventory management or directly to a refilling station, designated as item 210, as needed.

The ability to transmit data wirelessly ensures that hotel management can efficiently monitor liquid levels across multiple rooms and refilling stations, reducing the need for manual checks and improving operational efficiency. The NFC functionality 212 enables accurate tracking and management of each bottle's liquid levels and usage history, further enhancing the inventory management process.

FIG. 2D illustrates an embodiment of the invention where the handheld liquid level sensing device 200 is used in a bar or restaurant setting, specifically for monitoring beer kegs 211. With this embodiment, device 200 is placed against and thereby associated with the keg 211 to measure the remaining liquid level. The ultrasonic sensor 202 collects data, which is processed by the microcontroller 214 and displayed on the LED screen 204.

The device 200 also scans an NFC tag 212 attached to each keg 211 to identify it and transmit the liquid level data to a mobile device 208. This data is then forwarded to server 209 for centralized monitoring and inventory management. By providing real-time data on keg levels, bar and restaurant operators can better manage their stock and ensure timely refills, thereby minimizing downtime and optimizing service.

To accommodate different container types and sizes, the handheld liquid level sensing device 200 includes a calibration feature. Users can select the specific bottle or keg size from a mobile device 208, which adjusts the device's calibration settings to match the container's dimensions. This ensures precise liquid level measurements regardless of the container's shape or volume, enhancing the device's versatility across various applications.

Handheld device 200 is adaptable for use with various types of liquid containers where ongoing monitoring and accurate record-keeping are essential. Potential applications include measuring sanitizer levels in hospitals, tracking liquor inventory in retail environments, and managing oil levels in industrial settings. The device's ability to provide real-time, accurate measurements and transmit this data for centralized management makes it an invaluable tool for maintaining optimal inventory levels and reducing waste.

Having thus described the invention in rather full detail, it will be understood that such detail need not be strictly adhered to, but that additional changes and modifications may suggest themselves to one skilled in the art, all falling within the scope of the invention as defined by the subjoined claims.

We claim:

1) A utility holder for soap dispenser, comprising:
an enclosure adapted to mount on a wall;
a holding bracket attached at a bottom end of said enclosure to accommodate a soap dispenser;
a fixture clamp fastened at a top end of said enclosure for clamping said soap dispenser; and
a locking mechanism incorporated in said enclosure, to lock the height of said holder according to the dimensions of said soap dispenser;
a sensing module is integrated at the bottom end of said holder, wherein said sensing module comprises an ultrasonic gel pad to provide an acoustic isolation at the bottom of the soap dispenser for real-time detection of level of liquid soap within said soap dispenser.

2) The utility holder as claimed in claim 1, wherein said enclosure (102) has a hollow rectangular-shaped structure.

3) The utility holder as claimed in claim 1, wherein dimensions of said soap dispenser refer to the height of said soap dispenser.

4) The utility holder as claimed in claim 1, wherein said fixture clamp (104) has a shape selected from a semi-circular shape, and a circular shape.

5) A liquid dispenser system, comprising:
a dispensing unit having a holder and a container to hold a liquid to be dispensed;
at least one ultrasonic sensor coupled to a body of the holder to measure the amount of liquid within the container; and
an electronic unit coupled to the dispensing unit and including a sensing module, a processing module, and a communication module which enable the electronic unit to receive signals from at least one ultrasonic sensor, process them to provide values for display on a display device and communicate the values to a remote server over a network for inventory management.

6) A liquid dispenser system as recited by claim 5, comprising dual transducers for implementing a dual transducer measurement technique that provides accurate readings of the amount of said liquid with minimal resolution, whereby lower levels of said liquid within said container are accurately measured.

7) A liquid dispenser system as recited by claim 5, wherein said liquid within said container is liquid soap.

8) A liquid dispenser system as recited by claim 5, wherein said liquid within said container is an alcoholic beverage.

9) A liquid dispenser system as recited by claim 8, wherein said alcoholic beverage is beer.

10) A liquid dispenser system as recited by claim 8, wherein said alcoholic beverage is wine.

11) A liquid dispenser system as recited by claim 8, wherein said liquid dispenser system is housed within a handheld device.

12) A liquid dispenser system as recited by claim 8, wherein said handheld device is configured to be associated with a beer keg to measure the remaining liquid level of beer therein.

13) A liquid dispenser system as recited by claim 11, wherein said handheld device device further comprises calibration means associated with a mobile device for selecting a specific container size and adjusting settings of said calibration means to match dimensions of said container.

14) A liquid dispenser system as recited by claim 7, wherein said handheld device further comprises calibration means associated with a mobile device for selecting a specific container size and adjusting settings of said calibration means to match dimensions of said container.
